(19) United States
(12) Patent Application Publication
(10) Pub. No.: US 2007/0179217 A1
(43) Pub. Date: Aug. 2, 2007

(54) Flame-retarding and thermosetting resin composition

(75) Inventors: Kuen Yuan Hwang, Hsinchu (TW); Hong Hsing Chen, Hsinchu (TW); Bao Sheng Horng, Hsinchu (TW)

Correspondence Address: BIRCH STEWART KOLASCH & BIRCH, PO BOX 747, FALLS CHURCH, VA, 22040-0747, US

(73) Assignee: CHANG CHUN PLASTICS CO., LTD.

(21) Appl. No.: 11/476,820

(22) Filed: Jun. 29, 2006

(30) Foreign Application Priority Data
Jan. 27, 2006 (TW) 095103471

(51) Int. Cl. C08L 63/02

(52) U.S. Cl. 523/458; 428/403; 428/407; 525/523

(57) ABSTRACT

The present invention relates to a thermosetting resin composition, which comprises at least one titanium compound copolymerized composite as filler and can be used as mechanical, electrical and electronic parts, molded and/or packaging resin for semiconductor and so on, etc. By adding such titanium compound copolymerized composite, the resin composition of the present invention improves flame retardance and heat resistance and has an excellent moldability and reliance under circumstances without adding any other flame-resisting material.

### FIELD OF THE INVENTION

The present invention relates to a thermosetting resin composition, which comprises at least one titanium compound copolymerized composite as filler and can be used as mechanical, electrical and electronic parts, packaging resin for semiconductor and so on, etc. By adding such titanium compound copolymerized composite, the resin composition of the present invention improves flame retardance and heat resistance and has an excellent flame resistance and reliance. Particularly, it can resist cracks caused by weld and corrosion of metal wire under humidity and high temperature. Furthermore, the resin composition of the present invention can meet a requirement of UL regulation without using any other flame-resisting material.

### BACKGROUND OF THE INVENTION

Under consideration of economics and productivity, current mechanical, electrical and electronic parts and packaging materials for semiconductor devices are mostly made from an epoxy-based resin composition or a phenolic-based resin composition. To insure the use safety, such mechanical, electrical and electronic parts and semiconductor electronic components are required to meet a flame-retarding specification regulated by the UL. In order to attain the flame-retarding specification, materials as flame-retarding assistants such as a halogen-containing flame-retarding resin and diantimony trioxide are currently used to add into epoxy resin compositions or phenolic resin compositions for packaging. However, it is known that such flame retardants and flame-retarding assistants are harmful to human and animal. For example, diantimony trioxide has been classified a cancerogenic material, and the halogen-containing flame-retarding resin such as a bromine-containing epoxy resin may generate corrosive bromine free radical and hydrogen bromide during burning. Also, an aryl compound with high content bromine can produce toxic brominated furanes and brominated dioxins compounds which adversely affect human health and environment. Therefore, for the mechanical, electrical and electronic parts and the semiconductor packaging materials, person skilled in the art eagerly develops a flame-retarding resin with neither halogen nor diantimony trioxide to resolve pollution caused by using the halogen-containing epoxy resin and diantimony trioxide.

For the flame-retarding resins, phosphorus-containing and nitrogen-containing compounds are widely used as a new generation of flame retardants. Among others, phosphorus-containing and nitrogen-containing flame-retarding materials which are frequently used are, for example, non-reactive nitrogen-containing compounds such as melamine, cyanate containing triazine ring(s) and so on; non-reactive phosphorus-containing flame retardants such as red phosphorus, triphenyl phosphate (TPP), tricresyl phosphate (TCP), and ammonium polyphosphate; and non-reactive nitrogen-containing flame retardants such as melamine-containing dimer and trimer. In order to reach desired flame-retarding effect, it is necessary to incorporate such phosphorus-containing and nitrogen-containing compounds in a large amount into resin composition formulations. However, these compounds have poor moisture resistance because they absorb moisture easily or react with trace water to generate phosphine and corrosive phosphoric acid. Consequently, these phosphorus-containing and nitrogen-containing flame-retarding materials are unsuitable to use in the packaging of electronic parts which needs excellent moisture resistance.

In addition, there are also studies in using metal hydroxide(s) such as aluminum hydroxide and magnesium hydroxide and boron-based compounds as flame-retarding materials. Nevertheless, resin compositions cannot provide enough flame-retarding effect unless a large amount of the metal hydroxide(s) or boron-based compounds are used. Using a large amount of the flame-resisting materials can deteriorate the plasticity of the resin compositions which may further cause an unsuccessful molding.

Recently, under consideration of environmental protection and safety, reactive resin flame retardants gradually replace currently used flame retardants. Among others, a nitrogen-containing flame-retarding resin with reactivity has been widely used to substitute for a halogen-containing resin because it can bond to molecules of other ingredients and has higher heat stability. For instance, Japanese Patent Unexamined Publication 2000-297284 discloses a product of a reactive nitrogen-containing flame retardant obtained by reacting triazine compounds with formaldehyde. Japanese Patent Examined Publication 6-31276 discloses a flame retardant which is organic cyclic phosphorus-containing compounds. Furthermore, EP 0877040A1 discloses a phenolic resin composition containing triazine ring(s) which possesses flame retardance. Such reactive nitrogen-containing compounds have been broadly applied to resin compositions of manufacturing electronic products with requirement for flame retardance as flame retardants. Reactive nitrogen-containing flame-retarding resins which are currently developed are mostly phenolic-based resins. However, for semiconductor packaging, a resin composition based on the phenolic-based resins cannot improve its flame retardance due to the relatively low amount of the added resins.

To overcome technical disadvantages associated with the current mechanical, electrical and electronic parts and semiconductor packaging materials, the present inventors have broadly investigated into epoxy resin compositions and phenolic resin compositions. By utilizing the titanium compounds for promoting carbonization of epoxy and phenolic resins and by combining with phosphorus-containing and nitrogen-containing copolymerized composites, the present inventors have developed a thermosetting resin composition with high flame retardance and low moisture absorbability which comprises a titanium compound copolymerized composite as filler. Thus the present invention is completed.

### BRIEF DESCRIPTION OF THE INVENTION

The first objective of the present invention directs to a thermosetting resin composition, which comprises at least one titanium compound copolymerized composite as filler. The titanium compound copolymerized composite as filler is a product obtained by copolymerizing a titanium compound with nitrogen-containing compounds and/or phosphorus-containing compounds and the composite can be further coated with the thermosetting resin.

By utilizing the titanium compound copolymerized composite for promoting carbonization of the epoxy and phenolic resins and associating with synergistic flame-resisting effect of the phosphorus-containing and nitrogen-containing copolymerized composites, the present invention develops a thermosetting resin composition with high flame retardance and low moisture absorbability which comprises the titanium compound copolymerized composite as filler and can attain high flame-resisting effect with using in a low amount.

The second objective of the present invention directs to a thermosetting epoxy resin composition comprising an epoxy resin, a curing agent, a curing promoter, and a titanium compound copolymerized composite as filler, wherein the epoxy equivalent weight of the epoxy resin to the active hydrogen equivalent of the curing agent is in a ratio of from 1:0.5 to 1:1.5, and the amount of the curing promoter is from 0.01 to 5% by weight based on the total weight of the epoxy resin and the curing agent, and the amount of the titanium compound copolymerized composite is from 1 to 25% by weight based on the total weight of the epoxy resin and the curing agent.

The third objective of the present invention directs to a thermosetting phenolic resin composition comprising 20 to 60% by weight of phenolic resin, 2 to 12% by weight of curing agent, 1 to 8% by weight of curing promoter, and 35 to 75% by weight of inorganic filler in which a titanium compound copolymerized composite comprises 15 to 30% of the inorganic filler, wherein the % by weight is based on the total weight of the thermosetting phenolic composition.

In the above objectives of the present invention, the titanium compound copolymerized composite is a product obtained by copolymerizing a titanium compound such as titanate with a nitrogen-containing compound such as melamine and melamine cyanurate and/or a phosphorus-containing compound such as ammonium phosphate. The composite and the thermosetting resin can be also heated and kneaded to prepare a titanium compound copolymerized composite coated with the thermosetting resin. Such a composite can improve its compatibility in the thermosetting resin composition and endow the article prepared therefrom with better moisture resistance and reliance.

Due to the excellent flame-retarding effect and heat resistance, the titanium compound copolymerized composite of the present invention can be also incorporated into other thermosetting and thermoplastic resin materials as a flame retardant and used to manufacture various electronic products.

### DETAILED DESCRIPTION OF THE INVENTION

In the above any objective of the present invention, the thermosetting resin composition comprising the titanium compound copolymerized composite as filler can be used as mechanical, electrical and electronic parts and semiconductor packaging materials and can provide packaged objects with excellent flame retardance and heat resistance due to its excellent flame-retarding effect, heat resistance, and low moisture absorbability. Moreover, the titanium compound copolymerized composite of the present invention can be also used as a flame retardant or a stabilizer of resin materials other than epoxy resins and phenolic resins, such as a flame retardant or a stabilizer of other thermosetting resins and thermoplastic resins, and thus can be further used to manufacture various electronic products.

In the thermosetting epoxy resin composition of the second objective of the present invention, the epoxy resin is not particularly limited and can utilize epoxy resins that are ordinarily used in an epoxy resin composition. Examples of the epoxy resin may include novolac type epoxy resins, bisphenol type epoxy resins, biphenyl type epoxy resins, aromatic type epoxy resins containing three to four functional groups, diphenol type epoxy resins, dimethylphenol type epoxy resins, dicyclopentadiene type epoxy resins, naphthalene type epoxy resins, distyrene type epoxy resins, and sulfur-containing epoxy resins. Such resins can be used alone or in combination of two or more.

One embodiment of the above novolac epoxy resins is for example cresol novolac epoxy resin represented by the following formula (a) and phenol novolac epoxy resin. One embodiment of the biphenyl epoxy resins is, for example, a mixture of biphenyl-4,4′-glycidyl ether epoxy resin with 3,3′,5,5′-tetramethylbiphenyl-4,4′-glycidyl ether epoxy resin, as represented by the following formula (b). One embodiment of the aromatic epoxy resin containing three to four functional groups is, for example, a tetraphenyl alcohol ethane epoxy resin represented by the following formula (c). One embodiment of diphenol epoxy resin is, for example, a phenol biphenyl aralkyl epoxy resin represented by the following formula (d). One embodiment of dimethylphenol epoxy resin is, for example, phenol phenyl aralkyl epoxy resin. One embodiment of bisphenol epoxy resin is, for example, bisphenol A epoxy resin represented by the following formula (e). Bisphenol F epoxy resin, biosphenol S epoxy resin, and their analogs can be also used. Naphthol aralkyl epoxy resin can be used as well.

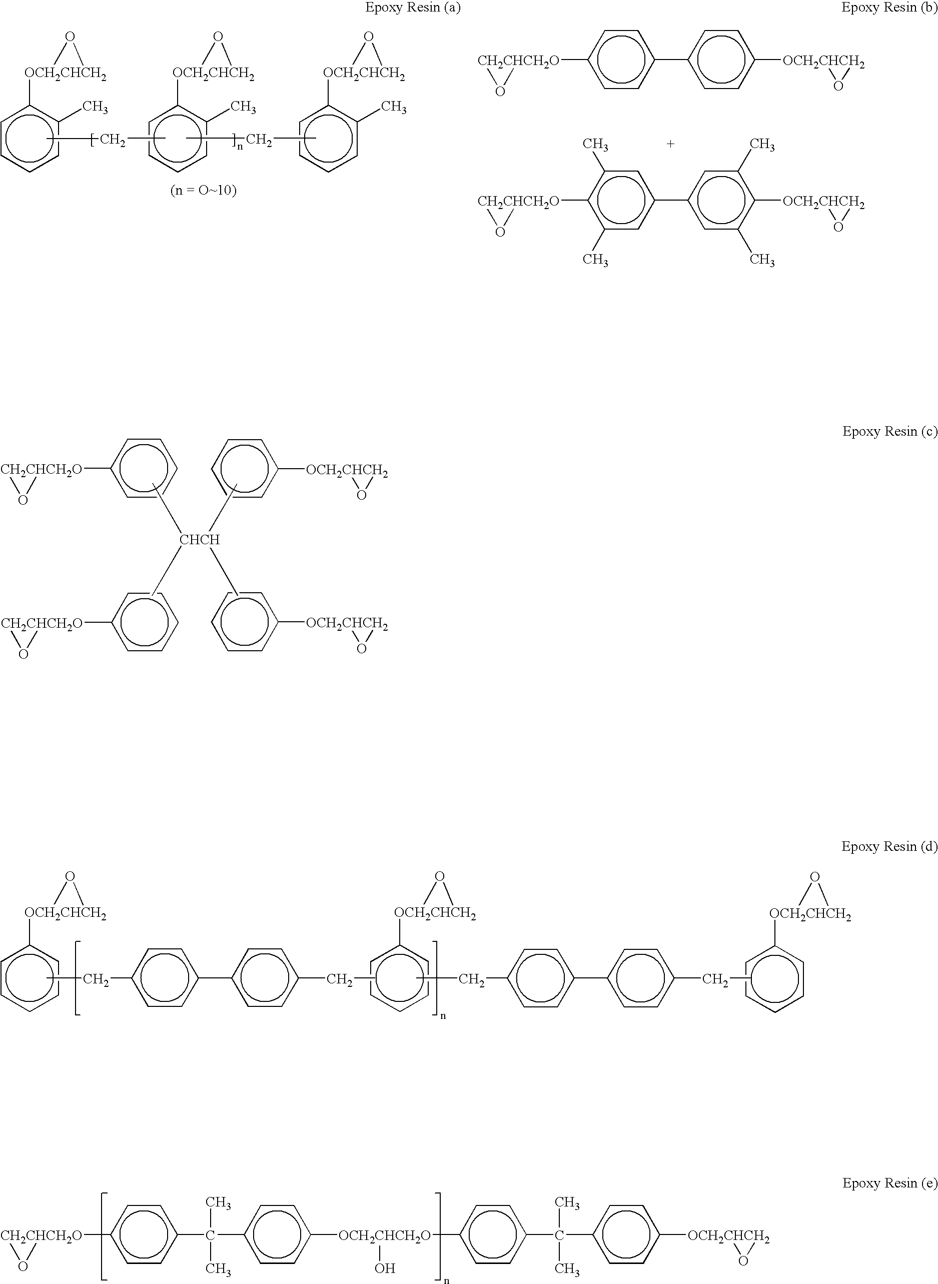

In the flame-retarding epoxy resin composition of the second objective of the present invention, the curing agent can be a curing agent containing active hydrogen(s) capable to react with an epoxy group or can be various halogen-free curing agents. Such a curing agent is not particularly limited and can utilize well known curing agents that are commonly used in epoxy resin compositions. Examples of the curing agent may include novolac phenol resin, aralkyl phenol resin, dicyclopentadiene phenol resin, biphenyl phenol resin, phenol epoxy resin, triphenyl methane phenol resin, bisphenol resin, polyhydroxyl phenol resin, phenolic and acid anhydride, phenyl alkyl polyamine, etc. The curing agent can be used alone or in combination of two or more.

Embodiments of the phenolic include, for instance, phenol-formaldehyde condensate represented by the following curing agent of formula (a), cresol phenolic condensae, bisphenol A phenolic condensae, or dicyclopentene phenolic condensate, etc.

Examples of the bisphenol resin include, for instance, a compound of the formula HO-Ph-X-Ph-OH (wherein Ph represents a phenylene group, X represents a bond, —CH₂—C(CH₃)₂—, —O—, —S—, —CO— or —SO₂—). Embodiments of the bisphenol resin include, for example, tetramethylbisphenol AD, tetramethylbisphenol S, 4,4′-biphenol, 3,3′-dimethyl-4,4′-biphenol, or 3,3′,5,5′-tetramethyl-4,4′-biphenol, etc. One embodiment of the phenol resin containing phenyl derivatives can be phenol phenylalkyl resin represented by the following curing agent of formula (b). One embodiment of the phenol resin containing biphenyl derivatives includes phenol biphenyl aralkyl phenol resin represented by the following curing agent of formula (c).

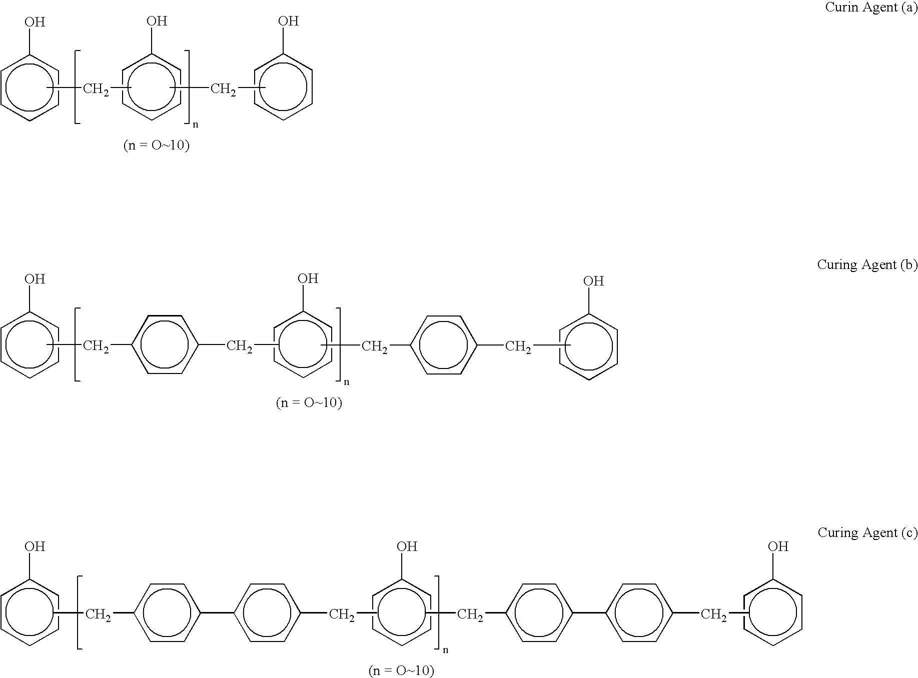

Embodiments of the polyhydroxylphenol resin include, for instance, tris(4-hydroxylphenyl)methane, tris(4-hydroxylphenyl)ethane, tris(4-hydroxylphenyl)propane, tris(4-hydroxylphenyl)butane, tris(3-methyl-4-hydroxylphenyl)methane, tris(3,5-dimethyl-4-hydroxylphenyl)methane, tetrakis(4-hydroxylphenyl)methane, or tetrakis(3,5-dimethyl-4-hydroxylphenyl)methane, etc. Moreover, in the phenol resin containing poly-aromatic group(s), naphthol aralkyl epoxy resin containing naphthalene derivatives can be used as well.

Embodiments of the acid anhydride include, for instance, 3,3′,4,4-benzophenone tetracarboxylic dianhydride (BTDA), trimetalitic acid anhydride (TMA) and pyromellitic acid dianhydride, etc.

The curing agent used in the flame-retarding epoxy resin composition of the present invention be also a nitrogen-containing and phosphorus-containing resin curing agent of the following formula (1): 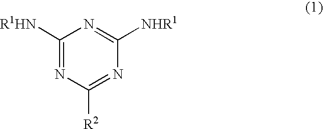
wherein R² represents —NHR₁, C₁₋₆alkyl, or C₆₋₁₀ aryl;
R¹'s individually represent a hydrogen atom, —(CH₂—R³—)ᵣH, or a group of the following formula (2): 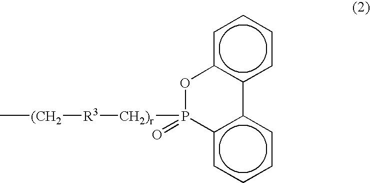
wherein r represents an integral number of from 0 to 20; R³ represents phenylene, napthalene, or a group of the following formula (3): 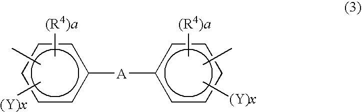
wherein A represents —O—, —S—, —SO₂—, —CO—, —CH₂—, —C(CH₃)₂—, or a group of the following group: 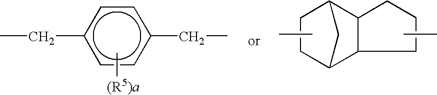
wherein R⁴ and R⁵ independently represent a hydrogen atom, C₁₋₁₀ alkyl, or C₆₋₁₀ aryl; Y represents —OH, —NH₂, or —COOH; a represents an integral number of from 0 to 2; x represents an integral number of from 0 to 3; and a+x is not greater than 3;
with a proviso that at least one R¹ is not a hydrogen atom.

In the thermosetting epoxy resin composition of the present invention, the curing promoter is not particularly limited and can utilize well known curing promoters that are commonly used in an epoxy resin composition. Examples of the curing promoter may include cycloimidazole compounds, maleic anhydride or quinone compounds, tertiary amine and its derivatives, imidazole and its derivatives, phosphorus compounds, tetraphenyl borate and its derivatives. Embodiments of the curing promoter may further include, for example, tertiary phosphine, quaternary ammonium salt, phosphonium salt, boron trifluoride complex, lithium compounds, or a combination thereof.

Embodiments of the tertiary amine include, for instance, trimethylamine, triethylamine, diisopropyl ethylamine, dimethyl ethanolamine, dimethylaniline, tris(N,N-dimethylaminomethyl)phenol, or N,N-dimethylaminomethylphenol, etc.

Embodiments of the tertiary phosphine include triphenylphosphine, etc.

Embodiments of the quaternary ammonium salt include, for example, tetramethylammonium chloride, tetramethylammonium bromide, triethylbenzylammonium chloride, triethylbenzylammonium bromide, or triethylbenzylammonium iodide, etc.

Embodiments of the phosphonium salt include tetrabutylphosphonium chloride, tetrabutylphosphonium bromide, tetrabutylphosphonium iodide, tetrabutylphosphate acetate complex, tetraphenylphosphonium chloride, tetraphenylphosphonium bromide, tetraphenylphosphonium iodide, ethyltriphenylphosphonium chloride, ethyltriphenylphosphonium bromide, ethyltriphenylphosphonium iodide, ethyltriphenylphosphate acetate complex, ethyltriphenylphosphate phosphate complex, propyltriphenylphosphonium chloride, propyltriphenylphosphonium bromide, propyltriphenylphosphonium iodide, butyltriphenylphosphonium chloride, butyltriphenylphosphonium bromide, or butyltriphenylphosphonium iodide, etc.

Embodiments of the imidazole compounds include, for example, 2-methylimidazole, 2-phenylimidazole, or 2-ethyl-4-methylimidazole, etc.

Such curing promoters can be used along or in a combination thereof.

In the thermosetting epoxy resin composition of the present invention, the amount of the curing agent depends on the epoxy equivalent weight of the epoxy resin and the active hydrogen equivalent of the curing agent. Generally, a ratio of the epoxy equivalent weight of the epoxy resin to the active hydrogen equivalent of the curing agent is in a range of from 1:0.5 to 1:1.5, preferably from 1:0.6 to 1:1.4, more preferably from 1:0.7 to 1:1.3.

In the thermosetting epoxy resin composition of the present invention, the amount of the curing promoter is from 0.01 to 5% by weight, preferably from 0.05 to 3% by weight, based on the total weight of the thermosetting epoxy resin composition of the present invention. If the amount of the curing promoter is more than 5% by weight, although reaction time may be shortened, byproducts are easily generated which adversely affect the electronic property, moisture resistance, water absorbability in the final use. If the amount is less than 0.01% by weight, the reaction rate is so slow that the production efficiency is decreased.

The amount of the curing promoter also depends on gelling time and viscosity of the thermosetting epoxy resin composition of the present invention. Generally, the curing promoter is added in an amount that controls the gelling time of the thermosetting epoxy resin composition in the range of from 30 to 500 sec/171° C., and the viscosity of the thermosetting epoxy resin composition in the range of from 20 to 500 cps/25° C.

The thermosetting epoxy resin composition of the present invention can further comprise other additives, such as inorganic filler other than the titanium compound copolymerized composite, coupling agents, pigments (e.g. carbon black and ferrous oxide), mold release agents, and low stress additives.

In the thermosetting epoxy resin composition of the present invention, examples of the inorganic fillers other than the titanium compound copolymerized composite include sphere shape and cornered shape molten silica, crystalline silica, aluminum oxide, zirconia, calcium silicate, calcium carbonate, potassium titanate, silicon carbide, silicon nitride, aluminum nitride, boron nitride, beryllium oxide, aluminum olivine, steatite, spinel, mullite, and titanium oxide, etc. Such fillers can be used alone or in combination of two or more. Sphere shape molten silica, cornered shape molten silica, crystalline silica, and a mixture of the sphere shape molten silica, the cornered shape molten silica and the crystalline silica are preferred.

An average particle size of the titanium compound copolymerized composite and the inorganic filler is preferably from 1 to 30 microns. If the average particle size is less than 1 micron, it will cause the increasing viscosity and decreasing flow ability of the resin composition. If the average particle size is more than 30 micron, it will result in uneven dispersion of the resin and of the filler in the composition, which will in turn affect physical properties of the cured article after curing the composition and cause resin overflowing during packaging and molding application. Additionally, the maximum particle size of the filler is preferably less than 150 microns to avoid leading to a narrow casting channel or poor filling of voids.

The amount of the filler of the titanium compound copolymerized composite is preferably from 1 to 25% by weight based on the total weight of the flame-retarding epoxy resin composition.

In addition to the titanium compound copolymerized composite, the thermosetting epoxy resin composition of the present invention may further comprise other fillers. The amount of the other fillers is to satisfy that the amount of the other filler plus the titanium compound copolymerized composite comprises from 60 to 92% by weight, preferably from 65 to 90% by weight of the total weight of the epoxy resin composition. If the amount of the total filler including the titanium compound copolymerized composite is less than 60% by weight of the epoxy resin composition, the relative ratio of the epoxy resin in the resin composition will be increased so that an overflowing of the resin easily occurs during packaging and molding. If the amount is more than 92% by weight of the epoxy resin composition, a viscosity of the resin composition will increase and result in the decrease of flowability.

In the thermosetting phenolic resin composition of the third objective of the present invention, the phenolic resin is not particularly limited and can utilize well known phenolic resins that are commonly used in a phenolic resin composition. Examples of the phenolic resin can be, for instance, novolac type phenol resin, aralkyl type phenol resin, dicyclopentadiene type phenol resin, biphenyl type phenol resin, phenol type phenol resin, triphenyl methane type phenol resin, etc. The phenolic resin is used in an amount of from 20 to 60 parts by weight, preferably from 25 to 55 parts by weight, based on the total weight of the thermosetting phenolic resin composition.

In the thermosetting phenolic resin composition of the third objective of the present invention, the curing agent is not particularly limited and can utilize well known curing agents that are commonly used in a phenolic resin composition. Examples of the curing agent include hexamethylenetetramine. The amount of the curing agent is from 2 to 12 parts by weight, preferably from 2.5 to 11.0 parts by weight, based on the thermosetting phenolic resin composition of the present invention.

In the thermosetting phenolic resin composition of the third objective of the present invention, the curing promoter is not particularly limited and can utilize well known curing promoters that are commonly used in a phenolic resin composition. Examples of the curing promoter include magnesium oxide, calcium oxide, calcium hydroxide, etc. Such curing promoter can be used alone or in combination of two or more. The amount of the curing promoter is from 1 to 8 parts by weight based on the total weight of the thermosetting phenolic resin composition.

In addition to the titanium compound copolymerized composite, the thermosetting phenolic resin composition of the third objective of the present invention may further comprise other inorganic fillers. Examples of the other inorganic fillers may include sphere shape and cornered shape molten silica, crystalline silica and the like, and quartz glass powder, talc powder, alumina powder, zinc borate, aluminum hydroxide, magnesium hydroxide, calcium carbonate powder, aluminum nitride, glass bead(s), glass fiber, etc. Such fillers can be used alone or in combination of two or more. The amount of the other filler is to satisfy that the other filler plus the titanium compound copolymerized composite comprises from 35 to 75 parts by weight, preferably from 40 to 70 parts by weight of the total weight of the thermosetting phenolic resin composition, wherein the amount of the titanium compound copolymerized composite comprises from 15 to 30% by weight of the whole filler.

The present invention will further illustrate by reference to the following synthesis examples, working examples, and comparative examples. However, these synthesis examples and working examples are not intended to limit the scope of the present invention.

### EXAMPLE

The epoxy equivalent weight (EEW), the viscosity, and a soften point used herein are determined according to the following methods.

(1) Epoxy Equivalent Weight: The epoxy equivalent weight is determined according to a method of ASTM 1652, in which the epoxy resin to be tested is dissolved in a mixture solvent of chlorobenzene chloroform in a ratio of 1:1, and the resultant mixture is titrated with HBr/glacial acetic acid by using crystalline violet as an indicator.

(2) Viscosity: The viscosity is determined by placing the epoxy resin to be tested in a thermostat maintaining at 25° C. for 4 hours and measuring the viscosity by using Brookfield Viscosmeter at 25° C.

(3) Soften point: The soften point is determined by applying the epoxy resin to be tested on an O-ring, placing a ball on the applied epoxy resin, gradually heating the epoxy resin, and measuring the temperature when the ball falls into the O-ring.

Each ingredient used in the following synthesis examples, working examples, and comparative examples are illustrated in detail as follows.

Epoxy Resin (a): A polyglycidyl ether of cresol-phenolic condensate having epoxy equivalent weight of 190 to 220 grams/equivalent and hydrolysable chlorine of below 500 ppm, available under trade name of CNE200EL/CNE195 sold and manufactured by Chang Chun Plastic Co., Ltd., Taiwan, R.O.C.

Epoxy Resin (b): 3,3′,5,5′-tetramethyl-4,4′-biphenol having epoxy equivalent weight of 195 grams/equivalent, available under trade name of YX4000H sold and manufactured by Yuka Shell Epoxy Co. Ltd., Japan.

Epoxy Resin (c): A tetraphenyl alcohol ethane epoxy resin having epoxy equivalent weight of 180 to 210 grams/equivalent and hydrolysable chlorine of below 500 ppm, available under trade name of TNE190 sold and manufactured by Chang Chun Plastic Co., Ltd., Taiwan, R.O.C.

Epoxy Resin (d): A phenol biphenyl aralkyl epoxy resin having epoxy equivalent weight of 260 to 290 grams/equivalent, available under trade name of NC3000 sold and manufactured by Nippon Kayaku Co. Ltd., Japan.

Epoxy Resin (e): A diglycidyl ether of bisphenol A having epoxy equivalent weight of 450 to 1000 grams/equivalent, available under trade name of BE500 sold and manufactured by Chang Chun Plastic Co., Ltd., Taiwan, R.O.C.

Epoxy Resin (f): A diglycidyl ether of tetrabromobisphenol A having epoxy equivalent weight of 350 to 370 grams/equivalent and bromine content of 23 to 26% by weight, available under trade name of BEB350 sold and manufactured by Chang Chun Plastic Co., Ltd., Taiwan, R.O.C.

Curing Agent (a): A curing agent having active hydrogen equivalent of 105 to 110 grams/equivalent, available under trade name of PF-5110 sold and manufactured by Chang Chun Plastic Co., Ltd., Taiwan, R.O.C.

Curing Agent (b): A phenol phenyl aralkyl resin having equivalent of about 176 grams/equivalent, available under trade name of MEH7800S sold and manufactured by Meiwa Plastic Industries, Ltd., Japan.

Curing Agent (c): A phenol biphenyl aralkyl phenol resin having equivalent of about 195 grams/equivalent, available under trade name of MEH7851 sold and manufactured by Meiwa Plastic Industries, Ltd., Japan.

Curing Promoter (a): Triphenylphosphine.

Curing Promoter (b): 2-methylimidazole (hereinafter refer to 2MI).

Titanium Compound Copolymerized Composite: Available under trade name of GY-series product sold and manufactured by Ho Yen Chemical Industrial Co., Ltd., Taiwan, R.O.C.

### [Synthesis Example 1] Preparation of a Titanium Compound Copolymerized Composite Coated with a Resin

A titanium compound copolymerized composite and an epoxy resin or a phenolic resin were placed into a container in weight ratio of 2:1 and thoroughly stirred by a mechanical stirrer. The mixture was sufficiently kneaded at a temperature of 95° C. by using a double-roll drum or a double-roll extruder, cooled and pulverized to obtain the titanium compound copolymerized composite powders coated with the epoxy resin and the titanium compound copolymerized composite coated with the phenolic resin, respectively.

### WORKING EXAMPLES And COMPARATIVE EXAMPLES

### Working Example 1—Preparation of a Thermosetting Flame-Retarding Epoxy Resin Composition

The thermosetting flame-retarding epoxy resin composition of the present invention was prepared from ingredients listed below.

| | |
|---|---|
| Epoxy Resin (a) | 15.4 parts by weight |
| Curing Agent (a) | 7.8 parts by weight |
| Curing Promoter (a) | 0.3 parts by weight |
| Titanium Compound Copolymerized Composite | 5.0 parts by weight |
| Silane Coupling Agent | 0.5 parts by weight |
| Silicone Dioxide | 70.0 parts by weight |
| Carbon Black | 0.4 parts by weight |
| Carnauba Wax | 0.6 parts by weight |

All of the above ingredients were charged into a container and thoroughly stirred by a mechanical stirrer. The mixture was sufficiently kneaded at a temperature of 95° C. by using a double-roll drum, cooled and pulverized to obtain the epoxy resin composition for semiconductor packaging.

### Working Examples 2 to 10 and Comparative Examples 1 to 6

Following the procedures of Working Example 1, the epoxy resin compositions of Working Examples 2 to 9 and Comparative Examples 1 to 5 and the phenolic resin composition of Working Example 10 and Comparative Example 6 were prepared from the ingredients and amounts listed in Table 1.

TABLE 1

| | Working Example No. | | | | | | | | | Comparative Example No. | | | | | |
|---|---|---|---|---|---|---|---|---|---|---|---|---|---|---|---|
| | 2 | 3 | 4 | 5 | 6 | 7 | 8 | 9 | 10 | 1 | 2 | 3 | 4 | 5 | 6 |
| Epoxy Resin (a) | — | 10.8 | — | | 10.2 | 15.8 | 15.8 | 15.8 | — | 15.8 | 15.8 | 15.8 | 15.8 | 15.8 | — |
| Epoxy Resin (b) | 15.8- | — | — | — | | — | | | | — | — | | — | — | — |
| Epoxy Resin (c) | — | — | 15.8- | — | — | — | — | — | — | — | — | — | | | |
| Epoxy Resin (d) | | 5. | | 16.4 | | | | | | — | — | — | — | — | — |
| Epoxy Resin (e) | | | | | 4.5 | | | | | | | | | | |
| Phenolic Resin | | | | | | | | | 38 | | | | | | 38 |
| Titanium/Nitrogen- | 5 | 5 | 5 | 5 | 5 | 5 | 5 | 25 | — | 1 | 30 | | | | |
| Containing | | | | | | | | | | | | | | | |
| Compound | | | | | | | | | | | | | | | |
| Copolymer | | | | | | | | | | | | | | | |
| Titanium/ | — | — | — | — | — | — | — | — | 10 | | | | | | |
| Nitrogen-Phosphorus- | | | | | | | | | | | | | | | |
| Containing | | | | | | | | | | | | | | | |
| Compound | | | | | | | | | | | | | | | |
| Copolymer | | | | | | | | | | | | | | | |
| Titanate | | | | | | | | | | | | 5 | | | |
| Aluminum Hydroxide | | | | | | | | | | | | | 5 | | 10 |
| Diantimony Trioxide | — | — | — | — | — | — | — | — | — | — | — | — | — | 2 | — |
| Epoxy Resin (f) | — | — | — | — | — | — | — | — | — | — | — | | — | 3 | — |
| Curing Agent (a) | 7.8 | 6.8 | 7.8 | 7.2 | 6.8 | — | — | 7.8 | | 7.8 | 7.8 | 7.8 | 7.8 | 7.8 | — |
| Curing Agent (b) | — | 1.0 | — | — | | 7.8 | — | — | — | — | — | — | — | — | — |
| Curing Agent (c) | — | — | — | — | — | — | 7.8 | | | | | | | | |
| Curing Promoter (a) | 0.3 | 0.15 | 0.3 | 0.3 | 0.15 | | 0.3 | 0.3 | — | 0.3 | 0.3 | 0.3 | 0.3 | 0.3 | — |
| Curing Promoter (b) | — | 0.15 | — | — | 0.15 | 0.3 | — | — | — | — | — | | — | — | — |
| Calcium Hydroxide | | | | | | | | | 1.9 | | | | | | 1.9 |
| Hexamethylene | | | | | | | | | 5 | | | | | | 5 |
| amine | | | | | | | | | | | | | | | |
| Molten Silicone | 70.0 | 70.0 | 70.0 | 70.0 | 70.0 | 70.0 | 50.0 | 50.0 | 9 | 74.0 | 45.0 | 60.0 | 70.0 | 70.0 | 9 |
| Dioxide | | | | | | | | | | | | | | | |
| Glass Fiber | | | | | | | | | 35 | | | | | | 35 |
| Trimethoxy Silane | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| Coupling Agent | | | | | | | | | | | | | | | |
| Carnauba Wax | 0.6 | 0.6 | 0.6 | 0.6 | 0.6 | 0.6 | 0.6 | 0.6 | 0.6- | 0.6 | 0.6 | 0.6 | 0.6 | 0.6 | 0.6- |

Characteristics of the flame-retarding thermosetting epoxy resin or phenolic resin compositions obtained from Working Examples 2 to 10 and Comparative Examples 1 to 6 were determined according to the following methods and results were shown in Tables 2 and 3.
(1) Helix flowability: According to a method of EMMI-1-66, the resin composition to be tested was determined its helix flowability at 175° C. and 70 kg/cm². The results were shown in Table 2.
(2) Flame resistance: The resin composition was made into a sheet having a dimension of 5″ length, 0.5″ width, and 1/16″ thickness and then tested its flame resistance according to UL 94 specification. Five sheets prepared from the same composition were taken and each sheet was burned twice. The test was passed if total burning time for 10 burnings did not exceed 50 seconds and each burning time did not exceed 10 seconds. The results were shown in Table 2. An average burning time was also calculated and shown in Table 3.
(3) Moisture absorbabilty: The resin composition was made into a circular sheet having a diameter of 25 mm and a thickness of 5 mm which was then weighted. The sheet was boiled in boiling water or pressure vessel at a temperature of 100° C. for 24 hours and then weighted again. The moisture absorption was calculated in percentage by weight.
(4) Heat resistance of reflow soldering: A chip having 18-pin dual leads (18LD-PDIP) were packaged with an epoxy resin composition or a phenolic resin composition at a temperature of 175° C. and cured at the same temperature for 4 hours. The cured article was treated under conditions of 85° C./85% relative humidity for 72 hours and then continuously heated in a solder tank at a temperature of 240° C. for 10 seconds in triplicate. The cured article was visually examined whether crack occurred on the appearance.

(5) Pressure Cook Test (PCT) Reliability: A 6A Diode was packaged with an epoxy resin composition or a phenolic resin composition at a temperature of 175° C. and then cured at the same temperature for 6 hours. After treating the 6A Diode package at 121° C./2 atm/100% relatively humility for 48 hours, the 6A diode package was tested its efficiency at low voltage and counted the defective rate. The defective rate is counted based on the following formula: defective rate (%)=number of the packages not passed the test/number of the tested packages X 100%, and the yield (%)=number of the packages passed the test/number of the tested packages X 100%.

TABLE 2

| | Working Example No. | | | | | | | | | Comparative Example No. | | | | | |
|---|---|---|---|---|---|---|---|---|---|---|---|---|---|---|---|
| | 2 | 3 | 4 | 5 | 6 | 7 | 8 | 9 | 10 | 1 | 2 | 3 | 4 | 5 | 6 |
| Helix | 75 | 75 | 82 | 70 | 75 | 75 | 75 | 78 | 78 | 72 | 80 | 75 | 70 | 75 | 65 |
| Flowability | | | | | | | | | | | | | | | |
| (cm) | | | | | | | | | | | | | | | |
| Flame | V-0 | V-0 | V-0 | V-0 | V-0 | V-0 | V-0 | V-0 | V-0 | V-0 | V-0 | V-1 | V-0 | V-0 | V-0 |
| Resistance | | | | | | | | | | | | | | | |
| UL-94 | | | | | | | | | | | | | | | |
| Moisture | 0.23 | 0.24 | 0.23 | 0.22 | 0.23 | 0.23 | 0.25 | 0.24 | 0.24 | 0.25 | 0.25 | 0.30 | 0.28 | 0.28 | 0.28 |
| Absorbability | | | | | | | | | | | | | | | |
| (%) | | | | | | | | | | | | | | | |
| PCT | >90% | >90% | >90% | >90% | >90% | >90% | >90% | >90% | >90% | 80% | 80% | 85% | 80% | 80% | 80% |
| Reliance | | | | | | | | | | | | | | | |
| Yield | | | | | | | | | | | | | | | |
| Note | | | | | | | | | | Poor | Poor | Poor | Poor | Bromine- | Poor |
| | | | | | | | | | | Flame | Reliance | Flame | Flame | Containing | Flame |
| | | | | | | | | | | Retardance | | Retard- | Retard- | Formulation | Retard- |
| | | | | | | | | | | | | ance | ance | | ance |

TABLE 3

| | Working Example No. | | | | | | | | | Comparative Example No. | | | | | |
|---|---|---|---|---|---|---|---|---|---|---|---|---|---|---|---|
| | 2 | 3 | 4 | 5 | 6 | 7 | 8 | 9 | 10 | 1 | 2 | 3 | 4 | 5 | 6 |
| Average | 2 to 3 | 2 to 3 | 1 to 2 | 2 to 3 | 1 to 2 | 1 to 2 | 2 to 3 | 1 to 2 | 1 to 2 | 10 | 1 to 2 | 10 | 10 | 1 to 2 | 10 |
| Burning | | | | | | | | | | more | | more | more | | more |
| Time(s) | | | | | | | | | | | | | | | |

### Working Examples 11 and 12

Following the procedures of Working Example 1, the epoxy resin composition and the phenolic resin composition of Working Examples 11 to 12 were prepared from ingredients and amounts listed in Table 4.

TABLE 4

| | | Working |
|---|---|---|
| | Working Example 11 | Example 12 |
| Epoxy Resin (a) | 13.3 | 15.8 |
| Epoxy Resin (b) | — | — |
| Epoxy Resin (c) | — | — |
| Epoxy Resin (d) | — | — |
| Epoxy Resin (e) | — | — |
| Phenolic Resin | — | — |
| Titanium Compound Copolymer | 7.5 | — |
| Coated with the Epoxy Resin | | |
| Titanium Compound Copolymer | — | 7.5 |
| Coated with the Phenolic Resin | | |
| Titanate | — | — |
| Aluminum Hydroxide | — | — |
| Diantimony Trioxide | — | — |
| Epoxy Resin (f) | — | — |
| Curing Agent (a) | 7.8 | 5.3 |
| Curing Agent (b) | — | — |
| Curing Agent (c) | — | — |
| Curing Promoter (a) | 0.3 | 0.3 |
| Curing Promoter (b) | — | — |
| Calcium Hydroxide | — | — |
| Hexamethylene amine | | |
| Molten Silica | 70.0 | 70.0 |
| Glass Fiber | | |
| Trimethoxy Silane Coupling Agent | 0.5 | 0.5 |
| Carnauba Wax | 0.6 | 0.6 |

Characteristics of the flame-retarding thermosetting epoxy resin compositions and phenolic resin composition obtained from Working Examples 11 to 12 were determined according to the foregoing methods and results were shown in Table 5.

TABLE 5

| | Working Example 11 | Working Example 12 |
|---|---|---|
| Helix Flowability (cm) | 76 | 77 |
| Flame Resistance UL-94 | V-0 | V-0 |
| Moisture Absorbability | 0.21 | 0.21 |
| (%) | | |
| PCT Reliance Yield | >90% | >90% |
| Average Burning | 1 to 2 | 1 to 2 |
| Time (s) | | |

In Working Examples and Comparative Examples, Working Examples 2 to 10 contain the titanium compound copolymerized composite of the present invention as fillers and each Working Example utilizes various epoxy resins or phenolic resin and curing promoters to prepare flame-retarding epoxy resin or phenolic resin compositions. Comparative Example 1 uses the titanium compound copolymerized composite of the present invention as filler in an amount less the lower limit mentioned above. Comparative Example 2 uses the titanium compound copolymerized composite of the present invention as filler in an amount more the upper limit mentioned above. Comparative Example 3 uses a common pure titanium compound. Comparative Example 4 uses a common metal hydroxide. Comparative Example 5 uses a bromine-containing epoxy resin and an antimony-containing flame retardant. From the above results, it is clear that those Working Examples and Comparative Examples exhibit flame retardance and comparable flame resistance and pass the UL94 V-0 test without affecting helix flowability. In view of heat resistance of reflow soldering, however, Working Examples 2 to 10 containing the titanium compound copolymerized composite of the present invention exhibit better flame resistance and PCT reliance yield than those of Comparative Examples.

Although Comparative Example 1 also uses the titanium compound copolymerized composite of the present invention as filler, it does not pass the UL94 V-0 test because the amount of the titanium compound copolymerized composite is only 1% by weight of the epoxy resin composition. Comparative Example 2 also uses the titanium compound copolymerized composite of the present invention as filler, although it pass the UL94 V-0 test, PCT reliance yield is relatively poor because the amount of the titanium compound copolymerized composite is more than 25% by weight of the epoxy resin composition.

Comparative Example 3 uses a pure titanium compound, but the obtained epoxy resin composition does not pass the UL94 V-0 test and exhibits poor moisture absorbability and PCT reliance yield.

Comparative Example 4 uses metal hydroxide, i.e., aluminum hydroxide, but the obtained epoxy resin composition does not pass the UL94 V-0 test and exhibits poor moisture absorbability and PCT reliance yield.

Comparative Example 5 uses a conventional bromine-containing epoxy resin and an antimony-containing flame retardant which attribute to a relatively low amount of used epoxy resin. When desired flame retardance is attained, the flowability of the epoxy resin becomes poor, and moisture absorbability and PCT reliance yield are worse than those of Working Examples utilizing the flame-retarding epoxy resin composition of the present invention.

### INDUSTRIAL UTILITY

The flame-retarding epoxy resin composition comprising the titanium compound copolymerized composite of the present invention as filler possess excellent flame retardance, heat resistance, low moisture absorbability, and moisture-resisting reliance. Therefore, without adding additional flame retardants, the resin composition of the present invention is useful as mechanical, electrical and electronic parts and semiconductor packaging materials. Also, a cured article prepared from the resin composition of the present invention exhibits excellent moldability and reliance.

Moreover, due to the excellent flame retardance and heat resistance, the flame retarding epoxy resin composition of the present invention is useful to prepare resin reinforced material prepregs, laminates, printing circuit boards, electronic packaging materials, semiconductor packaging materials, electronic parts such as connectors, transformers, power switches, relays, housing materials and coil materials, electronic products, automobile products, and machinery products, etc.

1. A thermosetting resin composition, which comprises at least one titanium compound copolymerized composite as filler and a thermosetting resin.

2. The thermosetting resin composition according to claim 1, wherein said titanium compound copolymerized composite is a product obtained by copolymerizing a titanium compound with nitrogen-containing compounds and/or phosphorus-containing compounds.

3. The thermosetting resin composition according to claim 1, wherein said titanium compound copolymerized composite is contained in said composition in a powder form coated with said thermosetting resin.

4. A thermosetting epoxy resin composition, which comprises an epoxy resin, a curing agent, a curing promoter, and a titanium compound copolymerized composite as filler, wherein the epoxy equivalent weight of said epoxy resin to the active hydrogen equivalent of said curing agent is in ratio of from 1:0.5 to 1:1.5, and the amount of said curing promoter is from 0.01 to 5% by weight based on the total weight of said epoxy resin composition, and the amount of said titanium compound copolymerized composite is from 1 to 25% by weight based on the total weight of said epoxy resin composition.

5. The thermosetting epoxy resin composition according to claim 4, wherein said titanium compound copolymerized composite as filler is a product obtained by copolymerizing a titanium compound with nitrogen-containing compounds and/or phosphorus-containing compounds.

6. The thermosetting epoxy resin composition according to claim 4, wherein said titanium compound copolymerized composite as filler is contained in said composition in a powder form coated with said thermosetting epoxy resin.

7. The thermosetting epoxy resin composition according to claim 4, wherein said thermosetting resin is an epoxy resin, which is selected from one or more group(s) consisting of novolac type epoxy resin, bisphenol type epoxy resin, biphenyl type epoxy resin, diphenol type epoxy resin, dimethylphenol type epoxy resin, dicyclopentadiene type epoxy resin, naphthalene type epoxy resin, distyrene type epoxy resin, and sulfur-containing epoxy resin.

8. The thermosetting epoxy resin composition according to claim 4, wherein said curing agent is selected from one or more group(s) consisting of novolac type phenol resin, aralkyl type phenol resin, dicyclopentadiene type phenol resin, biphenyl type phenol resin, phenol type epoxy resin, triphenyl methane type phenol resin, and a phosphorus-containing and nitrogen-containing compound of the following formula (1): 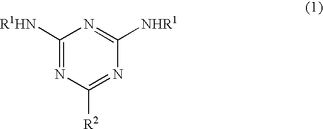
wherein R² represents —NHR¹, C₁₋₆ alkyl, or C₆₋₁₀ aryl;
R¹ individually represents a hydrogen atom, —(CH₂—R³—)ᵣH, or a group of the following formula (2): 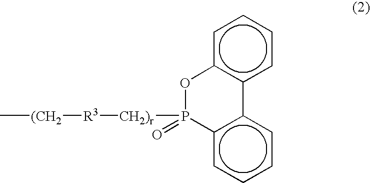
wherein r represents an integral number of from 0 to 20; R³ represents a phenylene group, a naphthalene group, or a group of the following formula (3): 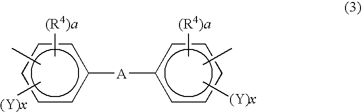
wherein A represents —O—, —S—, —SO₂—, —CO—, —CH₂—, —C(CH₃)₂—, or a group of the following group: 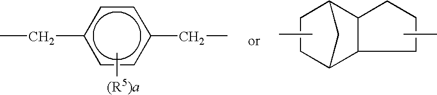
wherein R⁴ and R⁵ independently represent a hydrogen atom, C₁₋₁₀ alkyl, or C₆₋₁₀ aryl group; Y represents —OH, —NH₂, or —COOH; a represents an integral number of from 0 to 2; x represents an integral number of from 0 to 3; and a+x is not greater than 3; with a proviso that at least one R¹ is not a hydrogen atom.

9. The thermosetting epoxy resin composition according to claim 4, wherein said curing promoter is selected from one or more group(s) consisting of cycloimidazole compounds, maleic anhydride, quinone compounds, tertiary amine and its derivatives, imidazole and its derivatives, phosphorus compounds, and tetraphenyl borate and its derivatives.

10. The thermosetting epoxy resin composition according to claim 4, which further comprises at least one filler selected from the group consisting of molten silica, crystalline silica, aluminum oxide, zircon, calcium silicate, calcium carbonate, potassium titanate, silicon carbide, silicon nitride, aluminum nitride, boron nitride, beryllium oxide, zirconium oxide, aluminum olivine, steatite, spinel, mullite, and titanium oxide; in which the amount of the other fillers is to satisfy that the amount of the other filler plus the titanium compound copolymerized composite comprises from 60 to 92% by weight of the total weight of the epoxy resin composition.

11. The thermosetting epoxy resin composition according to claim 4, which further comprises one or more additive(s) selected from the group consisting of inorganic filler, coupling agents, pigments, mold release agents, and low stress additives.

12. A thermosetting phenolic resin composition, which comprises 20 to 60% by weight of phenolic resin, 2 to 12% by weight of curing agent, 1 to 8% by weight of curing promoter, and 35 to 75% by weight of inorganic filler in which a titanium compound copolymerized composite comprises from 0.15 to 30% by weight of the inorganic filler, wherein the % by weight is based on the total weight of the resin composition.

13. The thermosetting phenolic resin composition according to claim 12, wherein said titanium compound copolymerized composite as filler is a product obtained by copolymerizing a titanium compound with nitrogen-containing compounds and/or phosphorus-containing compounds.

14. The thermosetting phenolic resin composition according to claim 12, wherein said titanium compound copolymerized composite as filler is contained in said composition in the powder form coated with said thermosetting phenolic resin.

15. The thermosetting phenolic resin composition according to claim 12, wherein said phenolic resin is selected from one or more group(s) consisting of novolac type phenol resin, aralkyl type phenol resin, dicyclopentadiene type phenol resin, biphenyl phenol type resin, phenol type phenol resin, and triphenyl methane type phenol resin.

16. The thermosetting phenolic resin composition according to claim 12, wherein said curing agent is hexamethylenetetramine.

17. The thermosetting phenolic resin composition according to claim 12, wherein said curing promoter is selected from at least one group consisting of magnesium oxide, calcium oxide, and calcium hydroxide.

18. The thermosetting phenolic resin composition according to claim 12, wherein said inorganic filler is selected from the group consisting of sphere shape and cornered shape molten silica, crystalline silica, quartz glass powder, talc powder, alumina powder, zinc borate, aluminum hydroxide, magnesium hydroxide, calcium carbonate powder, aluminum nitride, glass bead(s), and glass fiber.
